(19) United States
(12) Patent Application Publication
(10) Pub. No.: US 2010/0141911 A1
(43) Pub. Date: Jun. 10, 2010

(54) EXPOSURE APPARATUS AND DEVICE MANUFACTURING METHOD

(75) Inventors: Keiji Emoto, Utsunomiya-shi (JP); Yutaka Watanabe, Shioya-gun (JP); Yasuyuki Tamura, Utsunomiya-shi (JP); Noriyasu Hasegawa, Utsunomiya-shi (JP); Kentaro Doguchi, Utsunomiya-shi (JP); Hisashi Namba, Utsunomiya-shi (JP); Keiji Yamashita, Utsunomiya-shi (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 12/632,457

(22) Filed: Dec. 7, 2009

(30) Foreign Application Priority Data
Dec. 9, 2008 (JP) 2008-313395

(51) Int. Cl. G03B 27/52; G03B 27/58

(52) U.S. Cl. 355/30; 355/72; 355/77

(57) ABSTRACT

An exposure apparatus, exposing a substrate via liquid so as to transfer a pattern of a mask onto the substrate, includes a stage configured to move while holding the substrate. The stage includes a substrate supporting portion on which the substrate is disposed, a supporting surface disposed outside the substrate supporting portion configured to support the liquid together with the substrate, and a frame portion formed so as to surround the supporting surface. The frame portion includes a depression and a member whose top surface is located in a plane including the supporting surface.

### BACKGROUND OF THE INVENTION

1. Field of the Invention

The present invention relates to exposure apparatuses and device manufacturing methods.

2. Description of the Related Art

Projection exposure apparatuses expose wafers to radiant energy so as to transfer patterns drawn on reticles (masks) onto the wafers using projection optical systems. Recently, immersion exposure has been attracting considerable attention as a way to meet the demand for high resolution. Immersion exposure is a technique for increasing the numerical aperture (NA) of a projection optical system by using liquid (immersion liquid) as a medium in the projection optical system adjacent to a wafer. When n is the refractive index of the medium and θ is the incident angle of light to be incident on an image plane, NA of the projection optical system can be expressed as NA=n×sin θ. Therefore, NA can be increased by up to n by filling a space between the projection optical system and the wafer with a medium having a refractive index higher than that of air, i.e., n>1. With this, the resolution R of the exposure apparatus, given by R=k1×(λ/NA), wherein k1 is a process factor and λ is the wavelength of a light source, can be reduced.

In immersion exposure, liquid is supplied to and recovered from a space on an optical path between the last surface of the projection optical system and the surface of the wafer such that liquid is locally applied. When a stage that transfers the wafer moves at high speed, immersion liquid that is thinly spread on the wafer cannot be completely recovered, and (1) the liquid remaining on the wafer spatters across the wafer, peripheral components of the wafer, or sensors disposed on the stage in some cases. In addition, (2) bubbles may enter the immersion liquid due to the instability of the film interface of the immersion liquid.

In case (1), liquid remaining on the wafer may cause an exposure defect. Moreover, liquid remaining on the peripheral components of the wafer may spatter outside the stage as the stage moves, and may affect other components. Furthermore, liquid remaining on the measuring sensors may cause measurement errors of the sensors, and may degrade exposure accuracy. In case (2), there is also a high probability that bubbles cause an exposure defect.

To solve the problem of case (1), Japanese Patent Laid-Open No. 2005-303316 describes an example, as shown in FIG. 19, having a rectangular groove 84 formed on the top surface of a stage 45A surrounding a wafer such that liquid remaining on the top surface of the stage does not spatter from the stage. Moreover, Japanese Patent Laid-Open No. 2005-101488 describes an example having a porous annular member 86 as shown in FIG. 20.

The rectangular groove described in Japanese Patent Laid-Open No. 2005-303316 and the porous annular member described in Japanese Patent Laid-Open No. 2005-101488 are formed so as to surround the entire circumference of an area in which a wafer is disposed.

In an immersion exposure apparatus, immersion liquid is retracted from the area in which a wafer is disposed to outside the groove or the porous annular member for measurement, and the liquid is transferred between two independent stages that perform positioning of wafers. Therefore, when the groove or the porous member is formed around the entire circumference of the area in which a wafer is disposed, the immersion liquid passes over at least a part of the groove or the porous member.

When the immersion liquid passes over the rectangular groove described in Japanese Patent Laid-Open No. 2005-303316, the interface of the immersion liquid becomes unstable, and bubbles may easily enter the immersion liquid.

On the other hand, in the porous annular member described in Japanese Patent Laid-Open No. 2005-101488, the pressure at a surface of the porous member adjacent to the bottom surface of the stage is adjusted so as to be more negative than that at a surface adjacent to the top surface, and is maintained such that liquid is absorbed by the porous member from the surface adjacent to the top surface of the stage. When the liquid is absorbed by adjusting the pressure at the bottom surface of the porous annular member so as to be negative while the immersion liquid passes over the porous member, the liquid easily vaporizes from the interior or the bottom surface of the porous member, and the heat of vaporization of the liquid causes heat removal. Changes in the temperature of the stage in the exposure apparatus cause thermal deformation of the stage, and lead to degradation of positioning accuracy of the stage, that is, degradation of exposure accuracy.

### SUMMARY OF THE INVENTION

The present invention is directed to an exposure apparatus whose exposure accuracy can be prevented from being degraded.

According to a first aspect of the present invention, an exposure apparatus, exposing a substrate via liquid so as to transfer a pattern of a mask onto the substrate, includes a stage configured to move while holding the substrate. The stage includes a substrate supporting portion on which the substrate is disposed, a supporting surface disposed outside the substrate supporting portion configured to support the liquid together with the substrate, and a frame portion formed so as to surround the supporting surface. The frame portion includes a depression and a member whose top surface is located in a plane including the supporting surface.

According to a second aspect of the present invention, an exposure apparatus, exposing a substrate via liquid so as to transfer a pattern of a mask onto the substrate, includes a stage configured to move while holding the substrate. The stage includes a substrate supporting portion on which the substrate is disposed, a supporting surface disposed outside the substrate supporting portion configured to support the liquid together with the substrate, and a catching portion capable of catching the liquid, formed so as to surround the supporting surface. The catching portion includes a depression and a supporting portion that can support the liquid together with the supporting surface.

According to a third aspect of the present invention, a method, using an exposure apparatus according to the first or second aspect of the present invention, includes exposing a substrate to radiant energy and developing the exposed substrate.

Further features of the present invention will become apparent from the following description of exemplary embodiments with reference to the attached drawings.

### BRIEF DESCRIPTION OF THE DRAWINGS

The accompanying drawings, which are incorporated in and constitute a part of the specification, illustrate exemplary embodiments of the present invention and, together with the description, serve to explain the principles of the invention.

FIG. 1 is a schematic view of an immersion exposure apparatus.

FIG. 2 illustrates the movement of two wafer stages according to a first exemplary embodiment.

FIG. 3 illustrates the movement of the two wafer stages according to the first exemplary embodiment.

FIG. 4 illustrates a path of an immersion region.

FIG. 5 illustrates the path of the immersion region.

FIG. 6 is a cross-sectional view illustrating an example of a depression.

FIG. 7 is a cross-sectional view illustrating another example of the depression.

FIG. 8 is a cross-sectional view illustrating yet another example of the depression.

FIG. 9 is a cross-sectional view illustrating yet another example of the depression.

FIG. 10 is a cross-sectional view illustrating an example of a predetermined member.

FIG. 11 is a cross-sectional view illustrating another example of the predetermined member.

FIG. 12 is a plan view of the predetermined member shown in FIG. 11.

FIG. 13 is a cross-sectional view illustrating yet another example of the predetermined member.

FIG. 14 is a plan view of the predetermined member shown in FIG. 13.

FIG. 15 is a cross-sectional view illustrating yet another example of the predetermined member.

FIG. 16 illustrates the movement of two wafer stages according to a second exemplary embodiment.

FIG. 17 illustrates the movement of two wafer stages according to a third exemplary embodiment.

FIG. 18 illustrates the movement of the two wafer stages according to the third exemplary embodiment.

FIG. 19 illustrates a known rectangular groove.

FIG. 20 illustrates a known annular member.

### DESCRIPTION OF THE EMBODIMENTS

Exemplary embodiments of the present invention will now be described in detail in accordance with the accompanying drawings. In the description, components with alphabet characters added to their reference numbers are generically referred to as those with the same reference numbers without the alphabet characters.

An exposure apparatus according to a first exemplary embodiment of the present invention will now be described with reference to the drawings.

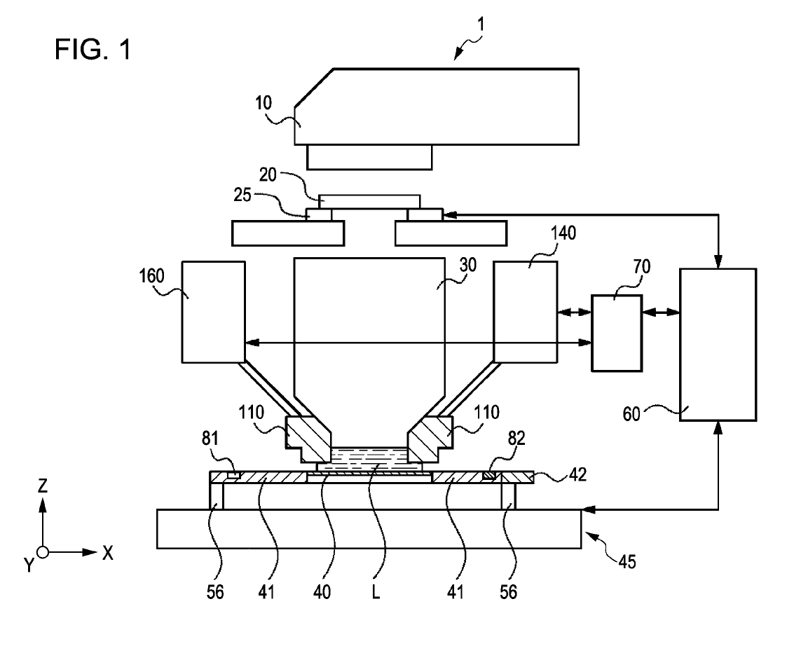

FIG. 1 is a schematic view of an immersion exposure apparatus 1. The exposure apparatus 1 exposes a wafer (substrate) 40 to radiant energy via liquid (immersion liquid) L supplied to a space between the final lens of a projection optical system 30 and the wafer 40 so as to transfer a pattern formed on a reticle (mask) 20 onto the wafer.

As shown in FIG. 1, the exposure apparatus 1 includes an illumination device 10, a reticle stage 25, a wafer stage (substrate stage) 45, and the projection optical system 30. The reticle stage 25 moves while holding the reticle 20. The wafer stage 45 moves while holding the wafer 40, and includes a substrate supporting portion on which the wafer 40 is disposed, a supporting surface (auxiliary member) 41 located outside the substrate supporting portion supporting the liquid together with the wafer 40, and a driving section.

Furthermore, the exposure apparatus 1 includes a stage controller 60 that controls drive of the reticle stage 25 and the wafer stage 45, a liquid supply/recovery device, and a liquid controller 70 that controls the liquid supply/recovery device.

The liquid controller 70 retrieves information on, for example, the position, velocity, and acceleration of the wafer stage 45 from the stage controller 60, and controls the immersion exposure process on the basis of the information. For example, the liquid controller 70 issues control commands to a liquid supply unit 140 and a liquid recovery unit 160 of the liquid supply/recovery device for controlling switching between the supply and recovery of the liquid L, stopping of the supply and recovery of the liquid L, and the amount of the liquid L to be supplied or recovered. The liquid L is supplied to a supply port of an immersion nozzle unit 110 and recovered from a recovery port of the immersion nozzle unit, and the liquid L is held under the final lens of the projection optical system 30. Hereinafter, the region at which the liquid L is held is referred to as an immersion region.

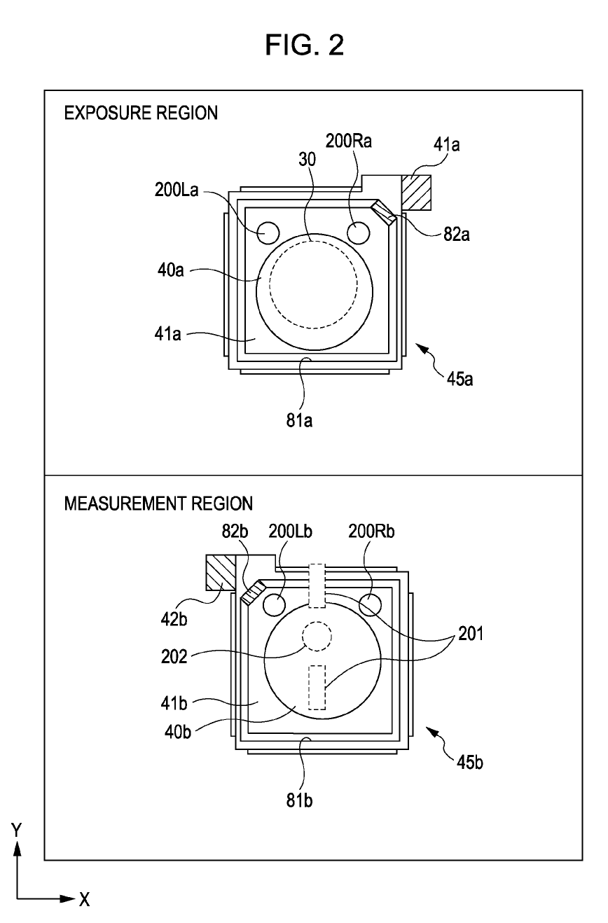

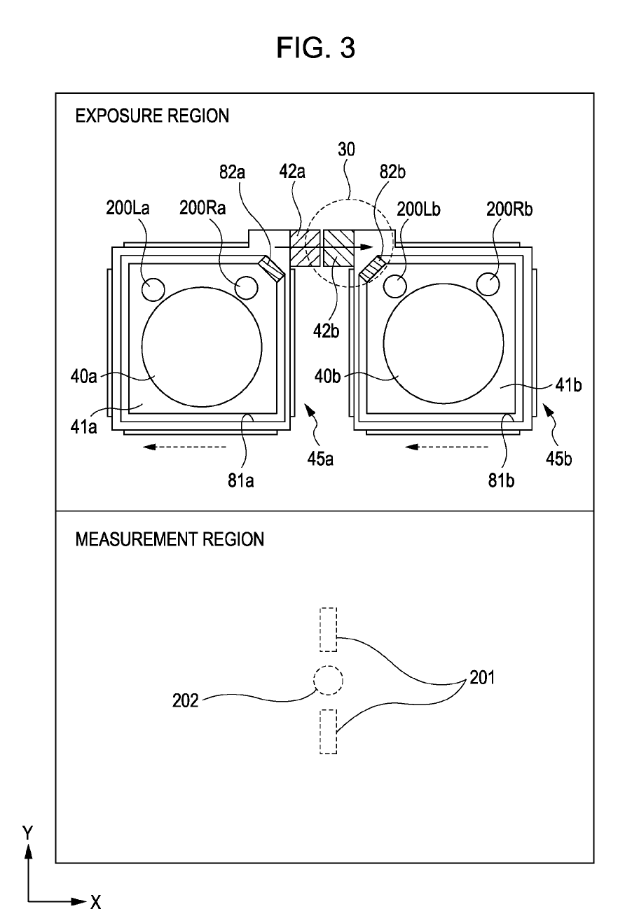

Next, the movement of wafer stages in an exposure system that allows exchange of a plurality of wafer stages while the liquid L is held under the surface of the final lens of the projection optical system 30 will be described. FIGS. 2 and 3 illustrate the movement of two wafer stages 45a and 45b in the exposure apparatus 1 that allows the wafer stages to alternately move to a measurement region and an exposure region for parallel processing of wafers.

In FIG. 2, the first stage 45a positions a wafer 40a in the exposure region, and at the same time, the second stage 45b positions a wafer 40b in the measurement region.

In the exposure region, the positions of the wafer 40a and the reticle 20 are measured, and the pattern of the reticle is transferred to the wafer 40a by exposure in every shot. In the measurement region, the positions of the wafer 40b and the wafer stage 45b are measured using an alignment scope 202, and the surface shape and the focus in the optical axis direction of the wafer 40b are measured using focus scopes 201.

As shown in FIG. 2, a protrusion 42a is formed in a hatched area located at an upper right position of the first stage 45a in this exemplary embodiment. Moreover, a protrusion 42b is formed in a hatched area located at an upper left position of the second stage 45b. These protrusions 42 are formed so as to support the liquid, and form a path through which the immersion region passes while being transferred to the other stage.

After the exposure of the wafer on the first stage 45a and the measurement of the wafer on the second stage 45b are finished, the stage 45b moves to a position adjacent to the stage 45a in the exposure region as shown in FIG. 3. At this moment, the protrusion 42a on the stage 45a and the protrusion 42b on the stage 45b are disposed so as to have a minute gap of about 0.1 to 1 mm therebetween, and move in a direction of arrows indicated by dotted lines such that the stage under the surface of the final lens is exchanged from the stage 45a to the stage 45b.

The peripheries of the portions of the protrusion 42a on the stage 45a and the protrusion 42b on the stage 45b, the portions of the protrusions being disposed adjacent to each other, are made water-repellent, and the liquid L does not enter the minute gap between the stages. Therefore, the stages 45a and 45b can be exchanged while the liquid L is held under the surface of the final lens.

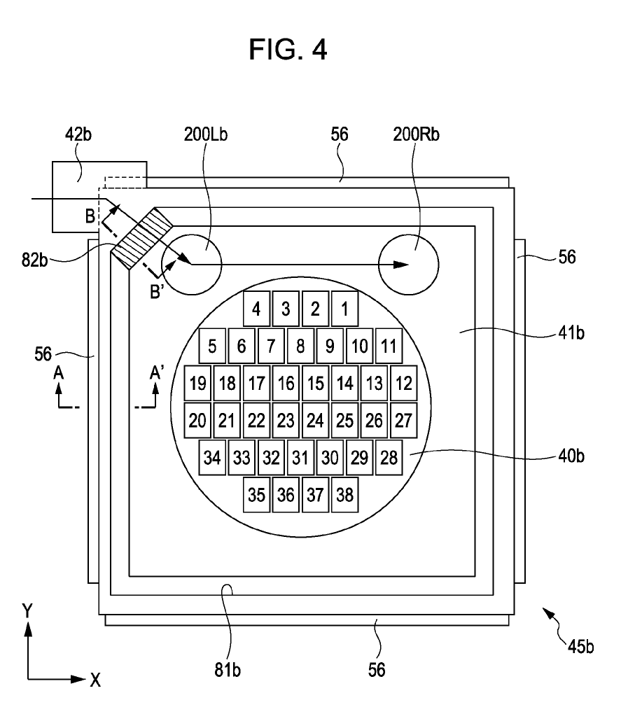

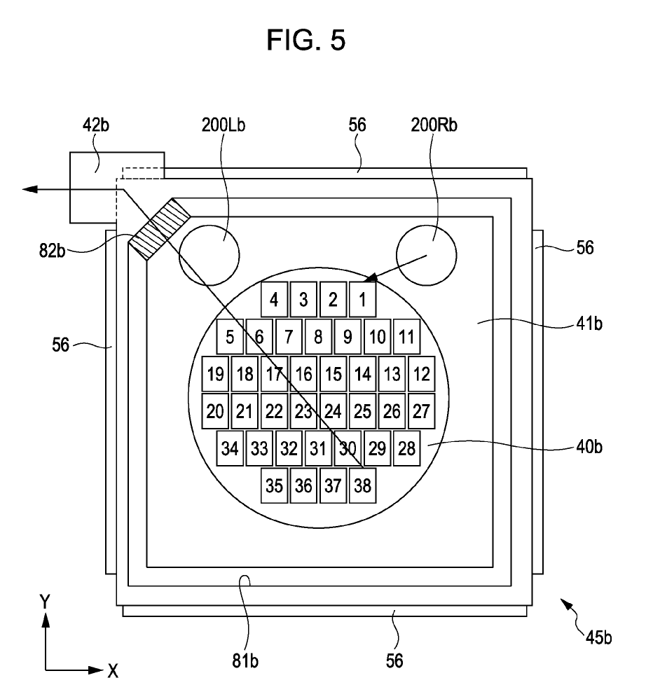

The movement of the stages will now be described with reference to FIGS. 4 and 5 in more detail. Arrows in FIGS. 4 and 5 show moving paths of the central portion of the immersion region (portion adjacent to the optical axis of the projection optical system) when the immersion region is transferred from the first stage 45a to the second stage 45b.

First, the two stages 45a and 45b move synchronously such that the immersion region is transferred onto the second stage 45b. Next, the second stage 45b moves such that the immersion region is disposed on a first reference mark 200Lb as shown in FIG. 4, and the positions of the stage and the reticle are measured. Subsequently, the stage moves such that the immersion region is disposed on a second reference mark 200Rb, and the positions of the stage and the reticle are measured. Through the series of these measurement processes, the relative positions of the reticle 20 and the second stage 45b are calculated, and a positioning reference is determined.

After the measurement processes on the second reference mark 200Rb, the immersion region is moved to a first shot position as shown in FIG. 5, and scanning exposure that scans in the Y-axis direction starts. In this exemplary embodiment, the first shot position is preferably as close as possible to the second reference mark 200Rb to reduce the processing time per wafer as much as possible.

After the thirty-eighth shot of exposure is finished, the immersion region is transferred to the protrusion 42b so that the stage on which the exposure is performed is changed, and the stages 45a and 45b are synchronously move again while being adjacent to each other as shown in FIG. 3. When the immersion region is transferred from the second stage 45b to the first stage 45a, the two stages 45a and 45b move in the +X-axis direction opposite to that shown by the dotted-line arrows shown in FIG. 3. In this manner, the stages can be exchanged.

The liquid controller 70 performs controls of the liquid L in the gap between the surface of the final lens of the projection optical system 30 and the wafer 40 using the liquid supply unit 140. With this, the gap between the surface of the final lens and the wafer 40 is kept filled with the liquid L by the liquid controller 70. In addition, while supplying the liquid L, the liquid controller 70 sucks and recovers the liquid L from the gap between the last surface of the projection optical system 30 and the wafer 40 using the liquid recovery unit 160, and drains the liquid outside the exposure apparatus 1 on a timely basis.

The liquid L is prevented from leaking from under the surface of the final lens of the projection optical system 30 and held under the surface of the final lens by being recovered from the recovery port of the immersion nozzle unit 110 by an amount equivalent to that of the liquid L supplied from the supply port.

However, since the liquid L is thinly spread on the wafer 40 as the wafer stage 45 moves, some of the liquid L cannot be recovered from the recovery port, and the liquid remains on the wafer 40 or on the supporting surface 41 in some cases. This remaining liquid moves on the wafer 40 or the supporting surface 41 as the wafer stage 45 moves, and may spatter outside the top surface of the wafer stage 45.

To avoid this, a liquid catching structure for catching the remaining liquid L is formed on the outer periphery of the supporting surface 41 disposed so as to surround the wafer 40 in this exemplary embodiment so that the liquid L does not move outside the top surface of the wafer stage 45.

The liquid catching structure (catching portion or frame portion) includes a depression (groove) 81 (81a, 81b) and a predetermined member 82 (82a, 82b) that forms the same plane as the supporting surface 41 (41a, 41b). The predetermined member 82 is disposed on a path over which the liquid L passes, and the liquid catching structure includes two different structures in accordance with areas.

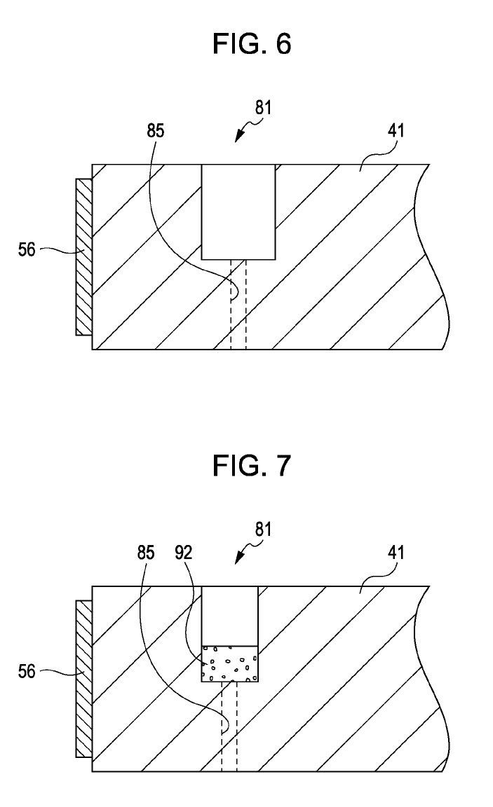

FIGS. 6 to 9 illustrate example structures of the depression 81. FIGS. 6 to 9 are cross-sectional views taken along line A-A′ in FIG. 4.

In FIG. 6, the cross section of the depression 81 of the liquid catching structure is rectangular. Although the liquid catching structure using the groove is simple, the liquid L remaining on the top surface of the wafer stage 45 can be reliably caught. The liquid L trapped in the depression 81 is sucked via a draining channel 85 on a timely basis, and drained outside the apparatus. The liquid L can be sucked and drained on a constant basis, or can be sucked and drained when a predetermined amount of liquid L is accumulated.

In FIG. 7, a porous body 92 is disposed on the bottom surface of the depression 81 shown in FIG. 6. With this structure, the remaining liquid collected on the bottom of the depression 81 is prevented from spattering from the depression 81 when the liquid is agitated as the wafer stage 45 moves.

Moreover, a portion of the liquid supporting surface adjacent to the outer periphery of the wafer stage 45 outside the depression 81 is made hydrophilic. This prevents the remaining liquid spattered over the depression 81 outside the periphery of the depression 81 from moving to reference mirrors 56 or onto a base. In general, when the liquid repellency of a surface is high, liquid forms droplets on the surface, and can easily move by sliding on the surface. Conversely, when the liquid repellency of a surface is low due to, for example, hydrophilizing treatment, liquid is spread and becomes a thin film, and does not move easily on the surface. On the basis of these characteristics, the liquid repellency of the liquid supporting surface outside the periphery of the depression 81 is intentionally reduced in this exemplary embodiment so that remaining liquid moved outside the periphery of the depression 81 is changed into thin films at the site. With this, the remaining liquid is prevented from spattering and moving to the reference mirrors 56 or the base.

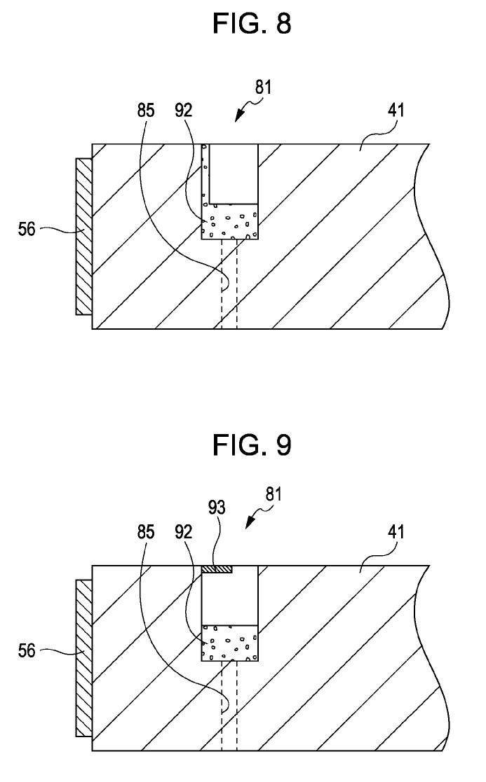

In FIG. 8, another porous body 92 is disposed on a side surface of the depression 81 in addition to the porous body on the bottom surface of the depression 81. When the remaining liquid moves from a central portion of the wafer to the depression 81 at a certain speed, the remaining liquid easily collides against the side surface of the depression 81. This may cause spattering of the remaining liquid. With consideration of this, the porous body 92 is also disposed on the side surface of the depression 81 in this exemplary embodiment so that the liquid is caught by the depression 81 and that the remaining liquid is prevented from spattering. In addition, another draining channel 85 can be provided for the porous body 92 disposed on the side surface of the depression 81 so as to suck the liquid.

In FIG. 9, a plate member 93 is disposed such that the remaining liquid is prevented from spattering to the peripheral area of the stage 45 or the top surface of the liquid supporting surface 41 even when the liquid collides against the side surface of the depression 81. Even when the remaining liquid collides against the side surface of the depression 81, the spattering liquid is blocked by the plate member 93 disposed at an upper part of the groove 84, and is prevented from spattering onto the liquid supporting surface 41 or outside the wafer stage 45.

The depression 81 having the above-described structures can catch the remaining liquid in a relatively reliable manner. Moreover, since the remaining liquid can be sucked while the immersion liquid is trapped in the depression 81, the remaining liquid can be efficiently recovered. Therefore, the heat of vaporization generated on the wafer stage can be regulated to a relatively small value even when the liquid is sucked and recovered.

In addition, since the remaining liquid is caught using the structure of the depression 81 and the liquid is recovered such that the liquid collected in the depression 81 does not overflow, it is not necessary to recover the liquid on a constant basis. Therefore, degradation of the positioning accuracy of the wafer stage 45 caused by the generation of the heat of vaporization can be suppressed by using the structure of the depression 81.

On the other hand, when the immersion region passes across the depression 81, air existing in the immersion liquid changes places with that existing in the depression as the immersion liquid falls into the depression 81, and bubbles easily enter the immersion liquid. The bubbles entering the immersion liquid degrades the optical characteristics of the apparatus and causes an exposure defect.

To avoid this, a predetermined member 82 is disposed in an area through which the immersion region passes instead of forming the depression 81 so as to surround the entire circumference of the supporting surface 41. The top surface of the predetermined member 82 is flush with the plane including the liquid supporting surface, and has a structure with which the remaining liquid does not spatter outside the wafer stage 45.

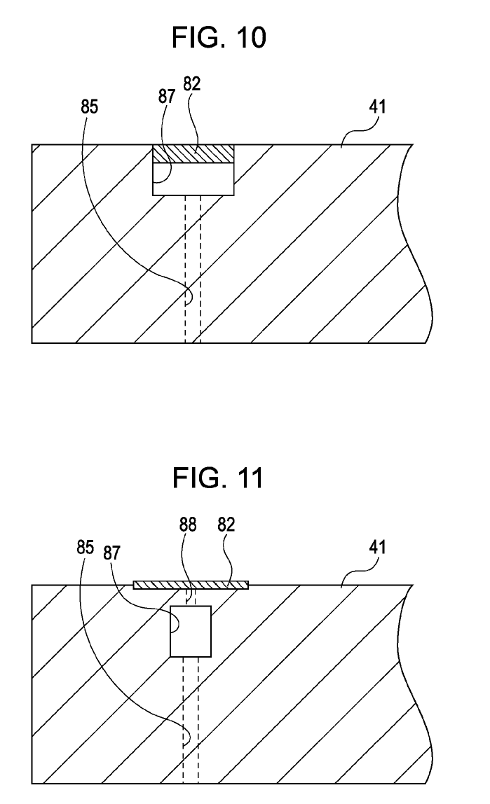

FIGS. 10 to 15 illustrate example structures of the predetermined member 82.

FIG. 10 is a cross-sectional view taken along line B-B′ in FIG. 4. In FIG. 10, a porous body serving as the predetermined member 82 is disposed such that the top surface thereof is flush with the plane including the liquid supporting surface 41 (in the same plane). Furthermore, a pressure control space 87 is formed at the rear surface of the porous body, and is evacuated to a negative pressure on a timely basis such that the remaining immersion liquid moving onto the top surface of the porous body can be sucked. The remaining liquid collected in the space 87 is sucked by a suction pump via the draining channel 85, and drained outside the wafer stage 45.

The immersion liquid can be driven to fall into the space 87 by the weight thereof without forming a negative pressure in the space 87 depending on the size of meshes of the porous body. In this case, however, bubbles may easily enter the liquid film when the immersion region passes across the porous body, and there is a high probability that the maintenance of the liquid film may become difficult. Therefore, the size of meshes of the porous body may be set small to a certain degree, and the liquid may be collected in the space 87 mainly by suction from the viewpoint of the maintenance of the liquid film. To this end, a negative pressure is formed at the rear surface of the porous body such that the liquid is reliably sucked and recovered whenever the remaining liquid moves onto the top surface of the porous body 86.

On the other hand, the suction at the rear surface of the porous body may be stopped or the amount of suction may be reduced when the immersion region passes such that the liquid is reliably held at the immersion region. The suction at the rear surface of the porous body can be continued on a constant basis using the same setting as long as the maintenance of the liquid is not affected.

Moreover, to enhance the capability to catch the remaining immersion liquid, the top surface of the porous body can be subjected to hydrophilizing treatment. With this, the remaining liquid moving onto the porous body is spread so as to stick thereto, and it becomes difficult for the liquid to move. When the remaining liquid is sucked in the space 87 via the porous body in this state, the remaining liquid can be reliably caught.

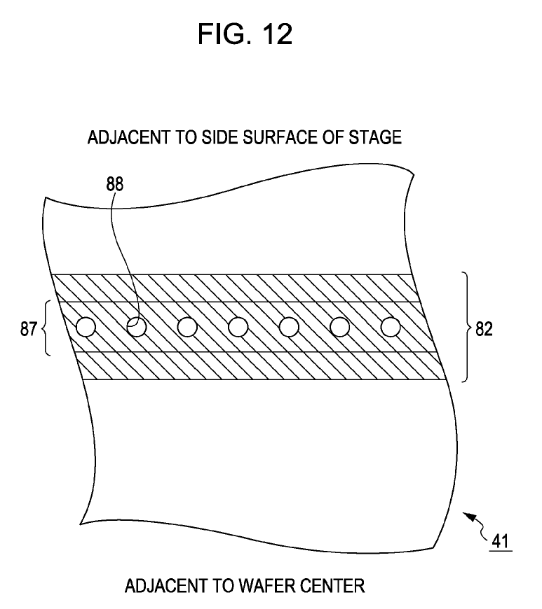

Next, an example of a component having a large number of pores serving as the predetermined member 82 is shown in FIGS. 11 and 12. FIG. 11 is a cross-sectional view taken along line B-B′ in FIG. 4. FIG. 12 is a plan view of a peripheral area of the predetermined member 82 viewed from the top surface of the wafer stage 45.

The predetermined member 82 is disposed such that the top surface thereof is flush with the plane including the liquid supporting surface 41 (in the same plane). Moreover, the surface of the predetermined member 82 is made hydrophilic, and has a large number of small holes (openings) 88 for suction and recovery connected to the pressure control space 87. The remaining liquid collected in the space 87 is drained outside the stage 45 via the draining channel 85 connected to the suction pump as in the case for FIG. 10.

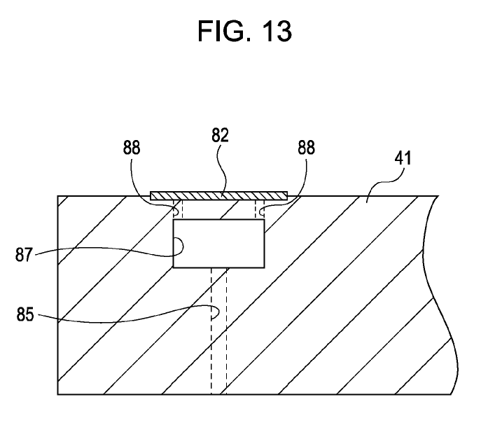

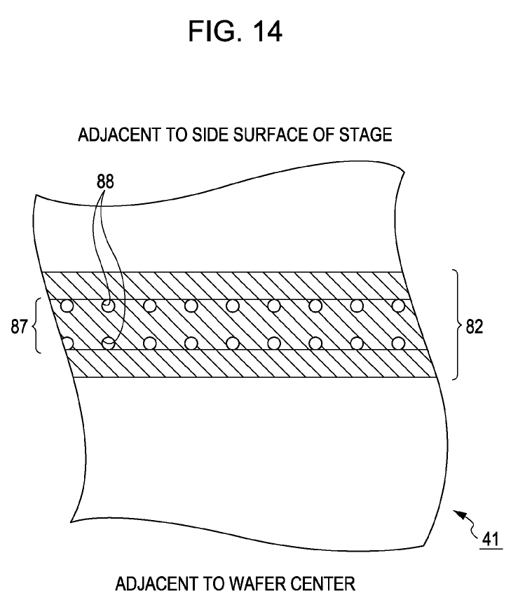

FIGS. 11 and 12 illustrate an example in which the large number of openings 88 are formed in the predetermined member 82 at a central region thereof in the width direction. On the other hand, FIGS. 13 and 14 illustrate an example in which the large number of openings 88 are formed in the predetermined member 82 at both ends thereof in the width direction. FIG. 13 is a cross-sectional view taken along line B-B′ in FIG. 4. FIG. 14 is a plan view of the peripheral area of the predetermined member 82 viewed from the top surface of the wafer stage 45.

In addition to the structures shown in FIGS. 11 to 14, a large number of holes can be formed in the entire predetermined member 82 in a uniform manner. The size and the array pitch of the openings 88 can be determined with consideration of, for example, the estimated amount of remaining liquid, the acceleration of the stage, the structure of the immersion nozzle unit 110, and the heat of vaporization to be generated. Moreover, a structure capable of catching the remaining liquid more efficiently with less effect on the maintenance of the liquid film can be applied.

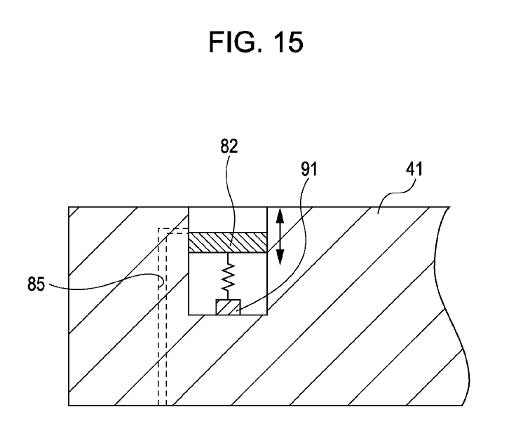

Next, another example of the predetermined member 82 will be described with reference to FIG. 15. The predetermined member 82 is disposed in the groove so as to be vertically movable. The top surface of the predetermined member 82 is disposed so as to be flush with the plane including the liquid supporting surface 41 (in the same plane) when the immersion region passes thereover. When the immersion region does not pass, the predetermined member 82 is lowered to the bottom surface of the groove so as to form a structure similar to the depression shown in FIG. 6. In this manner, the structure of the predetermined member does not affect the maintenance of the immersion region or does not allow bubbles to enter the liquid.

A driving mechanism 91 drives the predetermined member 82 vertically such that the groove is formed or that the height of the top surface of the predetermined member 82 becomes the same as that of the liquid supporting surface 41.

In the case where the predetermined member 82 is lowered so as to form the groove, the remaining liquid is caught in the groove. In the case where the height of the top surface of the predetermined member 82 is made the same as that of the liquid supporting surface 41, the top surface of the predetermined member 82 can hold the immersion liquid when the immersion region passes, and bubbles are prevented from entering the immersion liquid. The remaining liquid trapped by the top surface of the predetermined member 82 is sucked by the suction pump via the draining channel 85 on a timely basis.

The above-described liquid catching structure can advantageously reduce the number of times suction is performed and the generation of the heat of vaporization to a great extent. As a result, a reduction in the exposure accuracy caused by the exposure defect can be suppressed.

An exposure apparatus according to a second exemplary embodiment of the present invention will now be described with reference to the drawings.

In the first exemplary embodiment, the predetermined members 82 are disposed on the paths between the protrusions 42 disposed at the corners of the wafer stages 45 and the surfaces on which the wafers are disposed as shown in FIGS. 2 to 5. The protrusions 42 are used for preventing interference between the reference mirrors 56 for position measurement and optical axes formed thereby. That is, the immersion region can be transferred without the protrusions depending on the structure of the position measurement system.

In the second embodiment, the wafer stages 45 do not include the protrusions 42 at the corners thereof. Since the structure other than the absence of the protrusions is the same as that of the first exemplary embodiment, duplicated descriptions will be omitted.

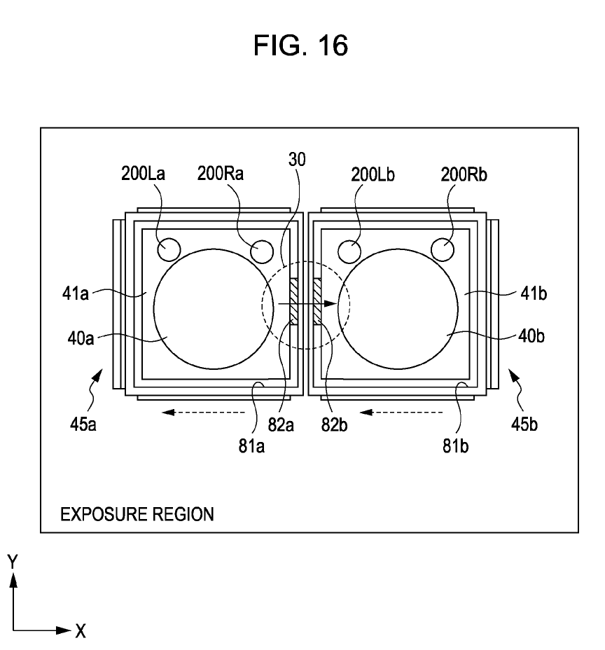

FIG. 16 illustrates an example structure of the wafer stages 45 according to this exemplary embodiment. In this exemplary embodiment, the immersion region is transferred by bringing the side surfaces of the wafer stages 45 close to each other.

Areas for transferring the immersion region are defined in a central portion of the right side surface of the first stage 45a and in a central portion of the left side surface of the second stage 45b. The predetermined members 82 (82a, 82b) are disposed in the respective areas of the liquid catching structures across which the immersion region passes. The depressions 81 (81a, 81b) are formed in the other areas of the liquid catching structures. The predetermined members 82 and the depressions 81 according to this exemplary embodiment can also have various structures as in the first exemplary embodiment.

In this exemplary embodiment, bubbles also do not enter the immersion region when the immersion region is transferred between the wafer stages, and the liquid film can also be held reliably. Moreover, since the area of the predetermined members 82 in which the heat of vaporization is easily generated is minimized, thermal deformation of the stages is also minimized.

Next, a third exemplary embodiment of the present invention will be described with reference to the drawings.

In the first and second exemplary embodiments, each of the predetermined members 82 is disposed in one area of the corresponding liquid catching structure since the immersion region passes only over the one area of each of the liquid catching structures when the immersion region moves between the stages.

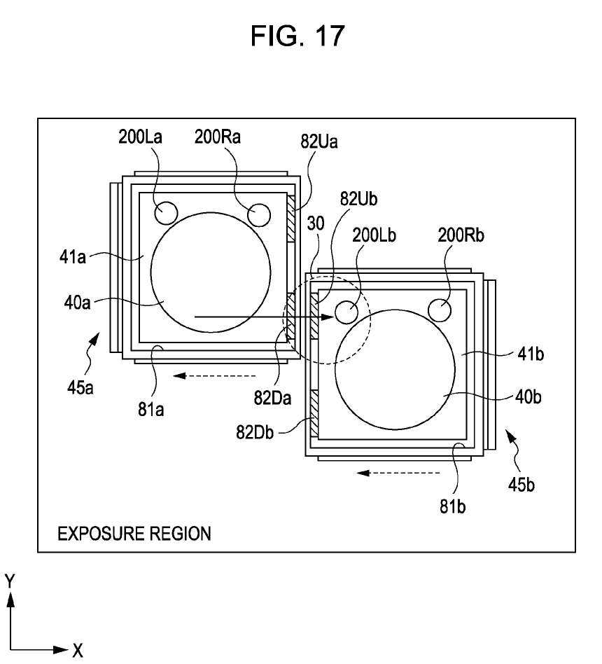

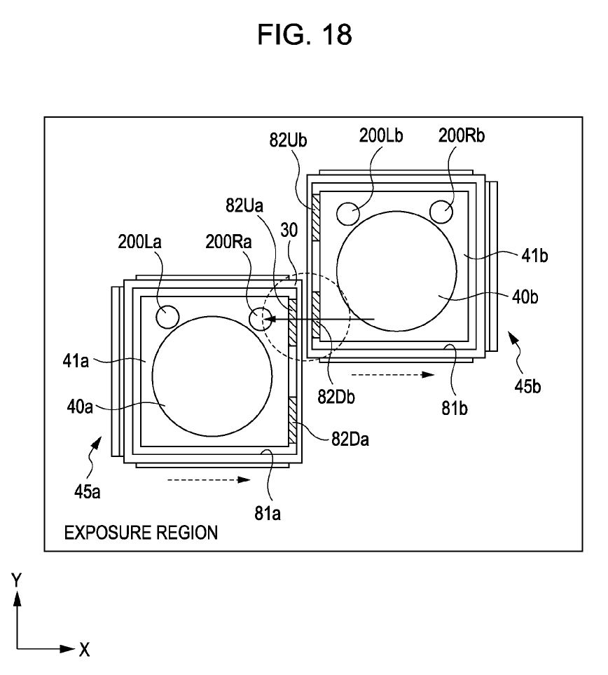

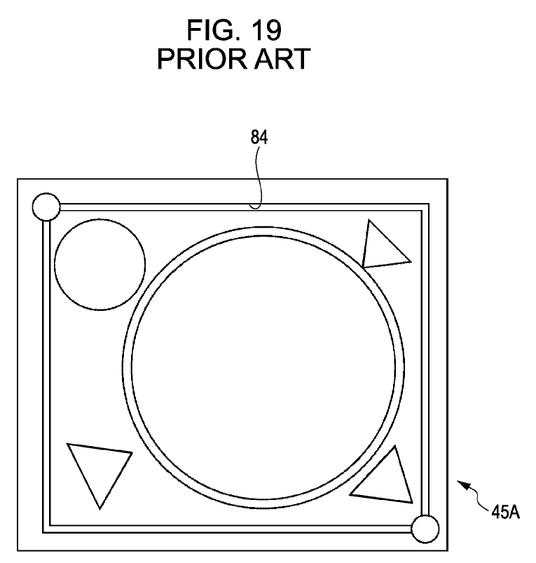

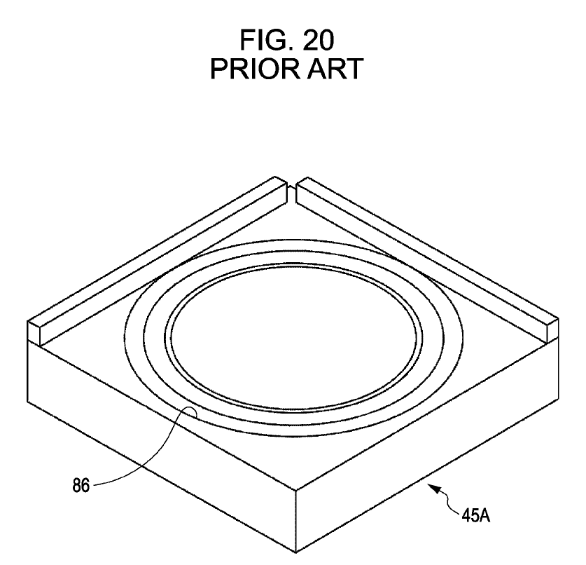

In the third exemplary embodiment, a system in which the immersion region passes a plurality of areas of the liquid catching structures will be described with reference to FIGS. 17 and 18. Since the structure other than the arrangement of the areas for transferring the immersion region is the same as those of the first and second exemplary embodiments, duplicated descriptions will be omitted.

Areas through which the immersion region passes while being transferred between the stages are defined in advance at two positions in the right side surface of the first stage 45a and at two positions in the left side surface of the second stage 45b.

As shown in FIG. 17, the immersion region located on the first stage 45a passes through an area 82Da of the first stage 45a and an area 82Ub of the second stage 45b in this order as the first stage 45a and the second stage 45b synchronously move in the direction of dotted-line arrows.

Subsequently, the immersion region moves to the first reference mark 200Lb on the second stage 45b, and then moves to the second reference mark 200Rb. Next, scanning exposure is performed on the wafer 40b.

Subsequently, the immersion region moves to an area 82Db of the second stage 45b so as to be transferred to the first stage 45a. Then, as shown in FIG. 18, the immersion region moves from the area 82Db of the second stage 45b to an area 82Da of the first stage 45a as the first stage 45a and the second stage 45b synchronously move in the direction of the dotted-line arrows.

Through the series of these movements, the immersion region passes across the two areas of each liquid catching structure. Therefore, the predetermined members 82 are disposed in the two areas in this exemplary embodiment. The depressions 81 are formed in the other areas of the liquid catching structures. The predetermined members 82 and the depressions 81 according to this exemplary embodiment can also have various structures as in the first exemplary embodiment.

With this structure, bubbles do not enter the immersion liquid when the immersion region passes, and the liquid film can be held reliably. Moreover, since the area of the predetermined members 82 in which the heat of vaporization is easily generated is minimized, thermal deformation of the stages is also minimized.

In this exemplary embodiment, the distances between the areas at which the immersion region is transferred and the reference marks are reduced as much as possible. Furthermore, the distances between the final shot positions at which the scanning exposure on each of the wafers 40 is completed and the areas at which the immersion region is transferred are also reduced as much as possible in advance. Therefore, the total moving distance of the immersion region on the wafer stages 45 is reduced compared with that in the first and second exemplary embodiments.

In general, when the immersion liquid moves while being held under the final lens of the projection optical system without generating the remaining liquid, it is beneficial to reduce the moving speed of the stages to a level lower than that in the case where the immersion liquid moves while not being held. Therefore, when a system is configured such that the moving distance the immersion liquid travels while being held is reduced as much as possible, the wafers 40 can be processed faster, and the productivity of the exposure apparatus can be improved.

Next, a method of manufacturing a device (semiconductor device, liquid crystal display device, etc.) as a fourth exemplary embodiment of the present invention will be described.

The semiconductor device is manufactured through a front-end process in which an integrated circuit is formed on a substrate such as a wafer, and a back-end process in which a product such as an integrated circuit chip is completed from the integrated circuit on the wafer formed in the front-end process. The front-end process includes a step of exposing the substrate coated with a photoresist to radiant energy using the above-described exposure apparatus of the present invention, and a step of developing the exposed substrate. The back-end process includes an assembly step (dicing and bonding), and a packaging step (sealing).

The liquid crystal display device is manufactured through a process in which a transparent electrode is formed. The process of forming a plurality of transparent electrodes includes a step of coating a substrate such as a glass substrate with a transparent conductive film deposited thereon with a photoresist, a step of exposing the substrate coated with the photoresist thereon to radiant energy using the above-described exposure apparatus, and a step of developing the exposed glass substrate.

The device manufacturing method of this exemplary embodiment has an advantage, as compared with known device manufacturing methods, in at least one of performance, quality, productivity and production cost of a device.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2008-313395, filed Dec. 9, 2008, which is hereby incorporated by reference herein in its entirety.

What is claimed is:

1. An exposure apparatus exposing a substrate via liquid so as to transfer a pattern of a mask onto the substrate, the apparatus comprising:
a stage configured to move while holding the substrate, the stage including,
a substrate supporting portion on which the substrate is disposed;
a supporting surface disposed outside the substrate supporting portion configured to support the liquid together with the substrate; and
a frame portion formed so as to surround the supporting surface, wherein
the frame portion includes a depression and a member whose top surface is located in a plane including the supporting surface.

2. The exposure apparatus according to claim 1, wherein the member is porous.

3. The exposure apparatus according to claim 1, wherein the member has a plurality of openings.

4. The exposure apparatus according to claim 1, wherein
the member is vertically movable, and
the top surface of the member is disposed in the plane including the supporting surface when the liquid passes over the member.

5. The exposure apparatus according to claim 1, further comprising:
a projection optical system configured to project the pattern of the mask to the substrate, wherein
the member is disposed on a path through which the liquid supported by the projection optical system and the supporting surface passes.

6. The exposure apparatus according to claim 1, wherein the liquid can be recovered from the top surface of the member.

7. The exposure apparatus according to claim 1, further comprising:
a plurality of stages, wherein
the member is disposed on a path in each of the stages, the liquid being transferred between the stages through the paths.

8. An exposure apparatus exposing a substrate via liquid so as to transfer a pattern of a mask onto the substrate, the apparatus comprising:
a stage configured to move while holding the substrate, the stage including,
a substrate supporting portion on which the substrate is disposed;
a supporting surface disposed outside the substrate supporting portion configured to support the liquid together with the substrate; and
a catching portion capable of catching the liquid, formed so as to surround the supporting surface, wherein
the catching portion includes a depression and a supporting portion that can support the liquid together with the supporting surface.

9. A method using an exposure apparatus exposing a substrate via liquid so as to transfer a pattern of a mask onto the substrate, the apparatus including,
a stage configured to move while holding the substrate, the stage including,
a substrate supporting portion on which the substrate is disposed;
a supporting surface disposed outside the substrate supporting portion configured to support the liquid together with the substrate; and
a frame portion formed so as to surround the supporting surface, wherein
the frame portion includes a depression and a member whose top surface is located in a plane including the supporting surface, the method comprising:
exposing a substrate to radiant energy; and
developing the exposed substrate.

10. A method using an exposure apparatus exposing a substrate via liquid so as to transfer a pattern of a mask onto the substrate, the apparatus including,
a stage configured to move while holding the substrate, the stage including,
a substrate supporting portion on which the substrate is disposed;
a supporting surface disposed outside the substrate supporting portion configured to support the liquid together with the substrate; and
a catching portion capable of catching the liquid, formed so as to surround the supporting surface, wherein
the catching portion includes a depression and a supporting portion that can support the liquid together with the supporting surface.
